(19) United States
(12) Patent Application Publication
(10) Pub. No.: US 2018/0218439 A1
(43) Pub. Date: Aug. 2, 2018

(54) A SYSTEM AND METHOD FOR SELECTING JEWELS ONLINE AND PURCHASING USING OFFLINE JIOSKS

(71) Applicant: DEEPA JAGANNATH, BANGALORE (IN)

(72) Inventor: DEEPA JAGANNATH, BANGALORE (IN)

(21) Appl. No.: 15/763,094

(22) PCT Filed: Sep. 23, 2016
(86) PCT No.: PCT/IB2016/055688

§ 371 Date: Mar. 24, 2018

(30) Foreign Application Priority Data
Sep. 25, 2015 (IN) 5121/CHE/2015

(51) Int. Cl. G06Q 30/06; G06Q 10/02

(52) U.S. Cl. CPC G06Q 30/0633; G06Q 10/02; G06Q 30/0641; G06Q 30/0603

(57) ABSTRACT

The present invention relates to a system and method for online and offline shopping in conjunction. The system and method for online and offline shopping includes selecting a plurality of products in multiple shops/jiosks/locations through an online mode with specialized software suites that enable select products, combination offers, promotions and cross selling of products along with convenience shopping as an application. And then, with an availability of jiosk i.e. the physical sales showroom, a user can make trial on specific products showcased in various ways that enhance purchase experience value, share shopping details with their closed private social group thereby enabling a collective decision making process while wanting to purchase the interested products. The product can be jewelry, clothing and/or may be of any type of product/merchandise.

### FIELD OF INVENTION

The embodiments herein generally relate to system and method for purchasing jewels. Specifically, the embodiments herein particularly relate to a system and method for selecting precious jewels via online as well as feel, experience and purchase using offline jiosks.

### BACKGROUND AND PRIOR ART

Since times immemorial, man has always been fashioning weapons, clothes and jewellery in almost every thinkable way. Though early forms of jewellery were made of terracotta, stones, pebbles, even bones, and other materials, the fascination for jewellery grew with the discovery and usage of precious stones and metals such as gold, diamonds, rubies, silver, etc. From being, just symbols of status and wealth, these gems and metals have over the ages transformed into iconic fashion trends and signature styles.

Recently, the advent of branded jewelers and marts during the latter half of the twentieth century re-defined the world's jewellery market with inimitable marketing style and exquisitely designed large showrooms, gave greater artistic visibility to jewellery while new modern designs made them both attractive and more affordable. Today handcrafted traditional jewellery items compete with machine-designed jewellery, each having its own niche.

While deciding the jewellery of interest, finalization of the shortlisted jewels requires more time. As most jewelers would agree, the designs and items up for sale in their showrooms are very similar and differentiating or distinguishing factors are minimal and sometimes just pricing or discount oriented. Further, during festivals or any special occasions, seasons, everybody wants to buy a special jewel and furthermore, jewellery representatives at the retailer/showroom cannot engage all the customers and that may lead to loss of valuable customers. Accordingly, for a single purchase, the customer cannot take a group of people of their interest such as relatives, friends, and advisor and so on to the shop to select the jewels.

In recent times to avoid the rush, unnecessary travel, and then to do the search precisely without wasting time and to select the jewel according to the customer requirement people are going for online shopping. In the online shopping, the customer comfortably can select and shortlist according to their appeal and finalize the order by consulting with the group of their interest such as relatives, friends, advisor and so on.

However, in online shopping also some pitfalls are there in selecting precious jewels. Hence, the look of the jewel may vary if we view the jewel directly in reality. Further, the payment option and bargaining, getting discount offers, altering gifts, or convincing the jeweler for more offers is not possible in online shopping. Furthermore, the customer cannot trial the selected jewel in reality.

Therefore, there exists a need in the prior art to provide both online and offline shopping experience for the single purchase to the customer. While searching and selecting the jewels, the customer requires online shopping facility, by searching multiple options in the single system. At the same time, while finalizing the selected jewel, the customer needs offline facility by fixing prior appointment to visit the jiosk i.e., the specially designed showroom space. Before finalizing the jewel, the customer expects multiple trials and needs jewellery representatives immediately to assist them. At the time of payment, the customer needs to make decision on mode of payment, and to validate discount offers, gift vouchers, memberships and so on.

### OBJECTS OF THE INVENTION

Some of the objects of the present disclosure are described herein below:

A main object of the present invention is to provide a system and a method for searching precious jewels/jewels through online and purchasing the selected precious jewel(s) by enhancing customer experience in reality.

Another object of the present invention is to provide a system and a method for searching, identifying, and experiencing the feel and aura of selected precious ornaments/jewels of all varieties even if that belongs to a particular brand, retailer, jewelry showroom, expert designers, and so on.

Still another object of the present invention is to provide a system and a method for purchasing precious ornaments/jewels through online as well as in specially designed and equipped jiosks at select strategic locations and commercial hubs.

Yet another object of the present invention is to provide a system and a method for finalizing the precious ornaments/jewels within the jiosk, after performing multiple trials at the pre-fixed time.

Another object of the present invention is to provide a system and a method for finalizing the precious ornaments/jewels, at the jiosk after sharing/consulting with the group of the customer's interest.

Another object of the present invention is to provide a system and a method for purchasing the precious ornaments/jewels at the jiosk through and by using present software modules/suites as also getting discounts, gifts, loyalty points, club membership and so on.

Another object of the present invention is to provide a system and method for purchasing precious ornaments/jewels at the Mobile Jiosk i.e. specially designed jiosks fitted onto vehicles such as mini-vans, caravans, tempo travelers and mini-buses etc. that can be sent to strategic locations such as malls, commercial hubs, residential complexes, corporate houses, party and function venues etc.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

In view of the foregoing, an embodiment herein provides a system and a method for searching jewels online and purchasing jewels offline after multiple trials at the jiosk. In the system engine, a customer who wants to purchase a jewel requires to do a search, which is related to the jewel of interest from the database server comprising of various brands, jiosks locations, designer specials, discount products and so on. The customer can use any interfacing device, which has an application to access the system engine or through internet by accessing the server. After short-listing a set of jewels of interest, the customer can initiate order through online payment or by booking jiosk visit for trial on the short-listed jewels set at pre-booked time.

In some example embodiments, the system is provided for purchasing jewels offline after multiple trials at the jiosk. In which the list of selected jewels and customer details are transferred to the jiosk automatically. At the jiosk, the appointment schedule is confirmed with the customer and the selected jewels as per wish list are displayed to the respective customer at the time of appointment. After multiple trials by the customers, the jewels are finalized by experiencing the appearance in reality. Then discount and payment options are decided at the retail jiosk itself to complete the process of purchasing precious jewels.

According to an embodiment, the system may include a customer registration module, database module, login module, search engine module, wish list module, payment module, jiosk-visit booking module, jiosk transport module, jewel and gift delivery module and other optional modules. The system performs the activity based on a set of modules incorporated in the system. Each module may perform the activity that is assigned to them.

According to an embodiment, a method for online purchase of jewels by the customer can be achieved by allowing the customer to login to the system after registration and providing them a search engine to search the database to select the jewels of their interest. After selecting the jewels, the customer can decide for purchasing either through online or at the offline jiosk. If the customer requests for trial of the jewels then prior appointment shall be made by the jiosk-visit booking module. Further, if transportation is required for visiting the jiosk then this transport facility is also arranged accordingly.

According to an embodiment, a method for offline purchase of jewels by the customer at the jiosk is developed to enable purchase of jewels after performing multiple trials on the wish list jewels. The jiosk is a specially arranged and equipped separate space for dealing with the customer who has an appointment. The pre-booked customer's jewels of interest are displayed in front of them with different props, backgrounds, matching and lighting effects. The retailer jiosk representative allows the customer to perform trial on the jewels of interest in different ways. For more convincing selection the trial on the jewels of interest is projected on the huge wall display, and further, the customer is allowed to make a video and audio conference with the private social group of their interest. After finalizing the jewels, the mode of payment is also decided by the customer. The gift shipping facility and other offerings from the jiosk are delivered to the customer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a sample network of a system and methods for online and offline purchase of Jewels, according to an embodiment therein;

FIG. 2 illustrates a system modules for online and offline purchase of jewels, according to an embodiment therein;

FIG. 3 illustrates a system for online purchase of jewels by the customer, according to an embodiment therein;

FIG. 4 illustrates a system for offline purchase of jewels by the customer at the jiosk, according to an embodiment therein;

FIG. 5 illustrates a flowchart for methods of online purchase of jewels by the customer, according to an embodiment therein; and

FIG. 6 illustrates a process for offline purchase of jewels by the customer at the jiosk, according to an embodiment therein.

### BRIEF DESCRIPTION OF DETAILS OF EMBODIMENTS

The embodiments herein, and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

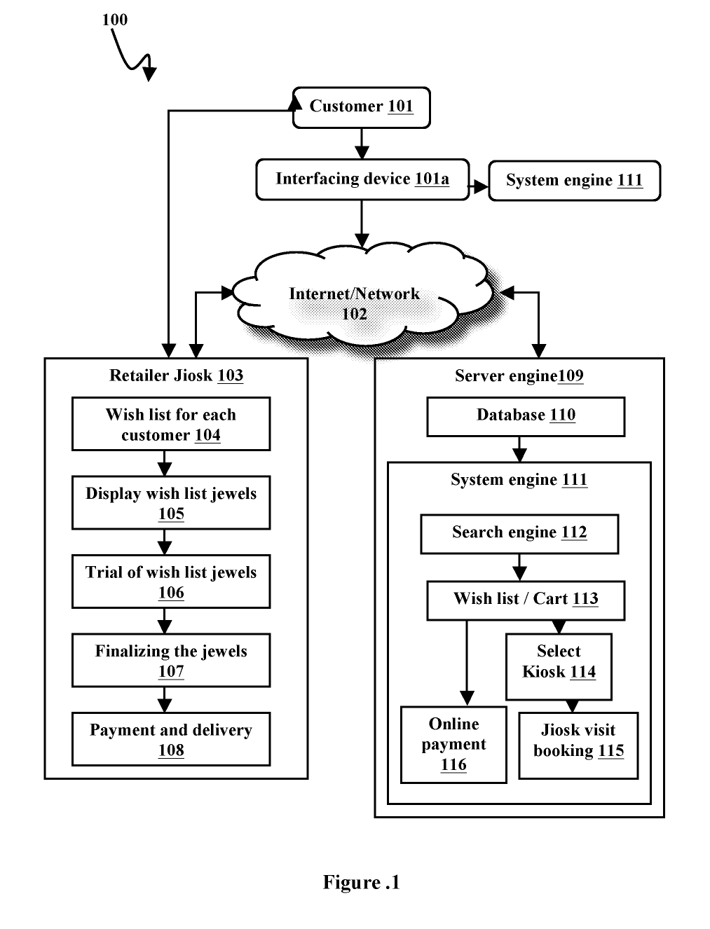

As mentioned above, there is a need of a system and a method for searching precious ornaments/jewels through online and purchasing the selected precious ornaments/jewels by enhancing customer experience in reality. The embodiments herein achieve this by providing a system and a method to search the jewels in online mode using internet and to purchase the selected jewels after multiple trials in the fixed time at the jiosk. Referring now to the drawings, and more particularly to FIGS. 1 through 6, where similar reference characters denote corresponding features consistently throughout the figures, there are shown preferred embodiments.

In some example embodiments, system and method is developed for searching jewels online and purchasing jewels offline after multiple trials at the jiosk. In the system engine, a customer who wants to purchase a jewel requires to do a search, which is related to the jewel of interest from the database server comprising of various brands, jiosks, designer specials, discount products and so on. The customer can use any interfacing device, which has an application to access the system engine or through internet by accessing the server. After short-listing a set of jewels of interest, the customer can initiate order through online payment or by booking jiosk visit for trial on the short-listed jewels set at pre-booked time.

In some example embodiments, the system is provided for purchasing jewels offline after multiple trials at the jiosk. In which the list of selected jewels and customer details are transferred to the jiosk. At the jiosk, the appointment schedule is confirmed with the customer and the selected jewels or wish lists are displayed to the respective customer at the time of appointment. After multiple trials by the customers, the jewels are finalized by experiencing the appearance in reality and in different ways to enhance shopping sentiments. Then discount and payment options are decided at the retail jiosk itself to complete the process of purchasing precious jewels.

FIG. 1 illustrates a sample network of system and methods 100 for online and offline purchase of Jewels, according to an embodiment. As shown in FIG. 1, the sample network mainly comprises of customer 101, interfacing device 101a, internet/network 102, system engine 111, server engine 109, and retailer jiosk 103. Wherein, the customer 110 may be an existing customer or new customer or guest visitor of the system. In the system, the interfacing device 101a may be a Smartphone, mobile, Laptop, personal digital assistant PDA, Tablet, and so on. The interface devices 101a facilitate transmitting and receiving data over the network 102. The interface device 101a can permit the customer to interact with the system engine and/or server engine. The internet/network 102 can comprise a plurality of data processing nodes interconnected for the purpose of data communication. Other components of the network environment can utilize the network/internet to receive, transmit, and store data as well as for accessing remote resources.

In an embodiment, the retailer jiosk 103 can acquire information from the server engine 109 via the Internet or network 102. The information that is obtained related to the wish-list from the respective customer 104, and the details of the customer who booked for the jiosk visit. The retailer jiosk 109 may plan accordingly after receiving the customer to the jiosk. The prior appointment holder is placed in a showroom sale space, where the selected jewels are displayed 105 and further trial 106 and finalizing process 107 has been accomplished. After that, the payment and delivery 108 of the purchased jewels are performed at the retailer jiosk.

In an embodiment, the server engine 109 comprises of a database engine 110 and a system engine 111. In which, the database engine 110 comprises of set of information related to different types of jiosks, brands, products, latest designs and so on. The database may be utilized to get information related to the jiosks, brands, products, designs, types and so on. Further, the database stores the data processed by the server engine and/or system engine. The system engine 111 comprises of search engine 112, a wish-list/cart for selected jewels 113, jiosk selection 114, booking for jiosk visit 115, and online payment 116. Specifically, the system engine 111 can be utilized for processing registration, searching the database, storing of wish list, booking for jiosk visit, and payment. The service request is transmitted or received over a network 102 via the interface device 101a by applying any of the transfer protocols (e.g., Hyper Text Transfer Protocol (HTTP). The example embodiments described herein may be implemented in the interfacing device 101a by a software application installed on the interface device.

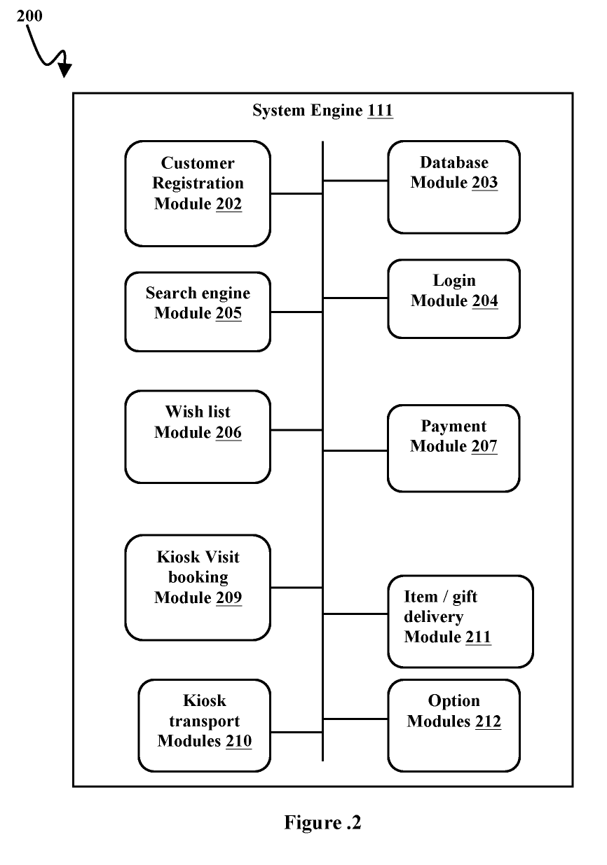

FIG. 2 illustrates system modules 200 for online and offline purchase of jewels, according to an embodiment. According to an embodiment, the system may include a customer registration module 202, database module 203, login module 204, search engine module 205, wish list module 206, payment module 207, jiosk-visit booking module 209, jiosk transport module 210, Item/gift delivery module 211 and option modules 212. The system performs the activity based on a set of modules incorporated in the system. Each module may perform the activity that is assigned to them.

According to an embodiment, the customer registration module 202 can be configured to register the customer 101 by means of interfacing device 101a. The customer can select the guest access or request for a new customer identity. By means of sign up option, new identity for the new customer is registered using customer registration module.

According to an embodiment, the database module 203 is provided in the server engine to acquire information related to different types of jiosks, brands, available products, latest designs, and so on. Further, the database module also stores the information related to a processing data such as wishlist, customer's jiosk priority, and jiosk-visit booking request by the system engine. The processed data is utilized for an offline mode operation that is at the retailer jiosks.

According to an embodiment, the login module 204 can be configured for existing customers who can login to the system by using their previous identity. The customer identity is verified and the login module allows the customer for accessing the existing customer privileges. Further, the login module restricts the guest customer from performing certain actions.

According to an embodiment, the search engine module 205 allows the customer to perform searches to select the jewels of their interest. The search can be made using the suggestion provided by the experts or advisors. The search can also be performed according to the brand, designs, purpose of the jewel, specific jiosks at specific locations, and latest designs that are available for sale. By applying search filters, the desired jewels are selected from the worldwide design database. According to an embodiment, the wish list module 206 performs the separation of the jewels in the wishlist according to their purpose and jiosks that has the wishlist jewels. According to the category, further process has been made by the system.

According to an embodiment, the payment module 207 includes the actions related to the payment for the purchase through online by means of debit or credit cards. According to an embodiment, the purchase payment at the jiosk in offline mode has been made at the retailer jiosks using debit or credit cards or by cash.

According to an embodiment, the jiosk-visit booking module 209 is provided to get an appointment from the retailer jiosk for making trial on the selected wishlist jewels. The customer can now book for an appointment at the jiosk either through the system by submitting a jiosk-visit request form or using the telephone calls the jiosk visit coordinator and requests for an appointment. The jiosk-visit request form contains details of number of visitors (adults and children), transportation requirements, preferred date and time of visit. According to an embodiment, the jiosk transport module 210 performs jiosk-visit appointment confirmation by specifying the date and time, which is then sent to the customer through mail as well as an SMS on their registered mobile number. Further, prior to the appointment schedule the jiosk-visit coordinator re-confirms the appointment with a mail and an SMS. If transportation has been sought, the cab is sent to the specified pick up address and customers are brought to the jiosk.

According to an embodiment, the item/gift delivery module 211 is provided to dispatch the jewels with a gift to the customer according to their preference. The purchased jewels can be gift wrapped and delivered directly to the customer or the purchased jewels can be dispatched to the address provided by the customer. Further collective gift facilities are also made available for the customers. Additionally corporate gifting facilities will be provided exclusively for corporates and other organizations.

According to an embodiment, the option modules 212 is provided for provisioning online games, updating the latest news about celebrity visit, providing information about loyalty points, uploading designs of new designers, announcing discounts and offerings, and gold bond or monetization schemes and so on.

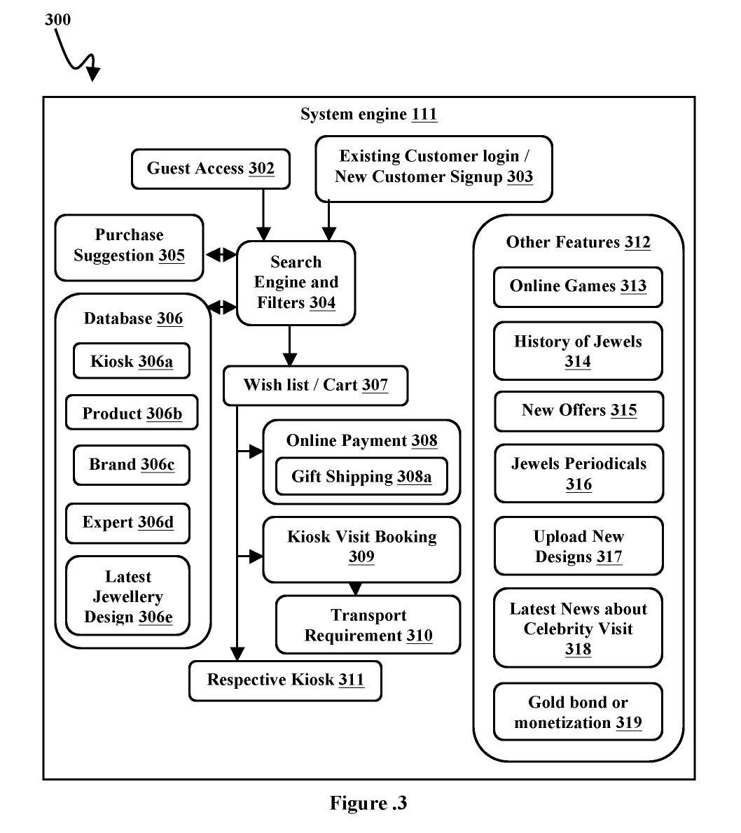

FIG. 3 illustrates a system 300 for online purchase of jewels by the customer, according to an embodiment. The system engine 111 in the online mode performs actions when the customer selects the type of login whether it may be a guest access 302, existing customer login, or a new customer login 303 using customer registration module 202. By means of the search engine module 205, the customer can shortlist the jewels of their interest from the database 306 according to the purchase suggestion 305, jiosks 306a, brands 306c, products 306b, latest designs 306e, expert advice 306d, location and so on. The search result is displayed as a jewel image, which includes selection options such as buy, try and buy, like, and like to buy. As a guest, the customer can select like for the jewels of their interest. Whereas, the existing or new customer, the customer can select the jewel according to their priority. After selection of the wishlist/cart 307, the customer can decide the mode of payment such as online payment 308 using buy option otherwise payment after trial by using try and buy or like to buy option. If the online payment 308 mode is selected means then the customer can choose gift shipment 308a or normal dispatch. If the customer wants for trialing means, they can get appointment for visiting jiosk 309 by means of jiosk visit booking module 209 and further transport requirement 310 is arranged by the jiosk transport module 210. Then the wishlist 307 with customer details is transferred to the respective retailer jiosk 311.

According the embodiment, the system in the online mode has also other features such as online games 313, history of jewels 314, new offers 315, jewellery related periodicals 316, upload for new designs 317, latest news about celebrity visit 318, and gold monetization 319. In which, the online games 313 are provided to cheer up the customer to earn reward points that can be used for purchasing jewels. In the option of history of jewels 314, may contain a repository of information regarding jewellery, ancient wisdom, vaastu, history about these jewels, science of jewel making, details of design, jewels manufacturing processes, and expert's opinion about jewels. The new offers 315 that are provided in the market are also displayed in the other features. In the embodiment, the periodicals 316 comprises of cartoons, online magazines, gemology truths, the jewellery brand can show case details of gemology experts, celebrities who are their brand ambassadors and their business partners through the system. In the upload for new design 317, budding designers can upload their jewellery design for empanelment. In the latest news about celebrity visit 318, important announcements related to the showroom visits by celebrities and these expects can be shared with the customers via the system. The gold monetization 319 option enables a seamless integration of the online system with the respective authorized banks.

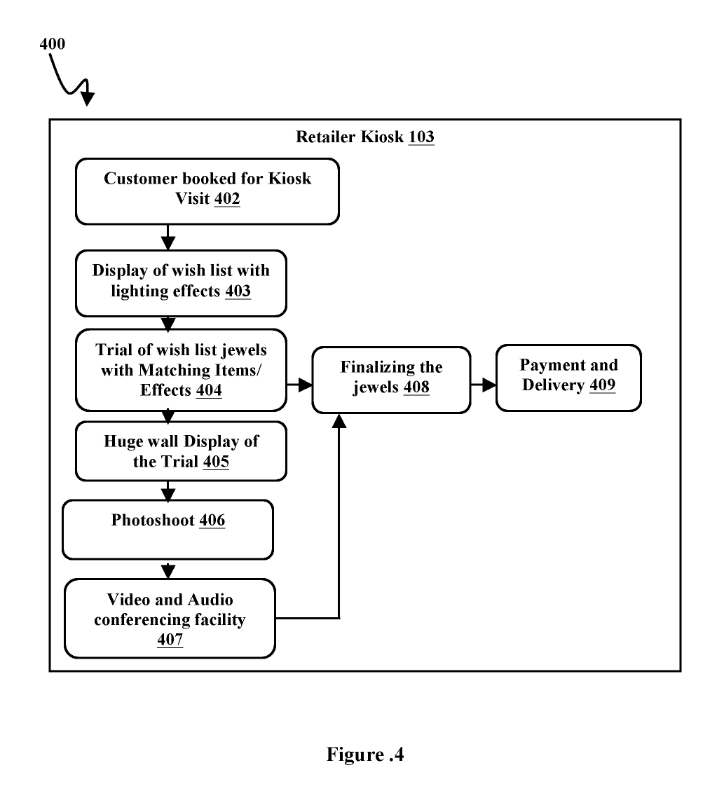

FIG. 4 illustrates a system 400 for offline purchase of jewels by the customer at the jiosk, according to an embodiment. The system in the offline mode deals with the retailer jiosk 203. According to the embodiment, the system comprises of customer booking for jiosk visit 402, display of wish list with grid lighting effects 403, trial of wish list jewels with matching items/effects 404, huge wall display of the trial 405, photo shoot 406, video and audio conferencing facility 407, finalizing the jewels 408 and payment and delivery 409. In which the customer, who got the prior appointment for visiting the jiosk are received 402 at the jiosk's sale space. In the jiosk sale space, the jewels are displayed in front of the customer according to their wishlist with lighting effects 403. According to the embodiment, the trial of jewels in the wish list with matching items/effects has been made by the customer 404. For more convincible decision-making, the customer may get the huge wall display of the trial 405 and photo shoot session can also arranged 406. Further, they are allowed for video and audio conferencing facility with their social group of their interest 407 before finalizing the jewels. After finalizing the jewels 408, the payment and delivery 409 can be made according to their preference.

According to an embodiment, software suites and jiosk details provides a comprehensive software to sequentially and scientifically control the lighting, background and other ‘show’ modules (with manual option to slow, fast-forward, pause, extend time lag/lead, light and shade controls, etc.) with select jewels. To use complete area of the jiosk space efficiently (all round gridlighting (display) i.e. lighting under the table, jiosk sides, etc.). By means of the system modules (software plus firmware) the selected jewels are showcased based on parameters (defined) such as easily ‘showcaseable’ holders convenient loops with details of making items and accessories. In which the making item and accessories includes a comprehensive set of (artificial and natural) gems (colors), silver foils, aluminum foils, gold etc. in the form of straps (platinum base) foils, carvings, designs etc. for mix and match; stickers; lockets; letters; etc.

According to an embodiment, a 24-Carat Hour Jiosks are made available at select locations such as airports, malls and commercial hubs, exhibitions and boutiques. The 24-Carat hour facility, customers can visit the jewellery jiosks during transit times. Particularly, the key advantage is that at these locations security is present round the clock. Customers can visit those jiosks wherein contemporary books about jewellery, jewellery buying books, articles, and magazines are available. This type of jiosks gives the customers a real time feel for pre-purchase of jewellery. Target customers at these jiosks include HNIs, NRIs whose buying potential is high, customers purchasing for weddings and special occasions which in-turn helps to target a wider audience with higher potential to buy the jewels.

According to an embodiment, a unique day feature is a software feature present in the portal. In which, customer can tag and choose unique days for specific relatives or friends and business colleagues. Further, in the unique day feature option the selected people are tagged as Silver, Gold, Platinum, Diamond, or other chosen gems. The unique tagging is mapped to special day(s) of their life like birthday, wedding anniversary, golden jubilee celebration, diamond jubilee anniversary, special days and milestones, etc.

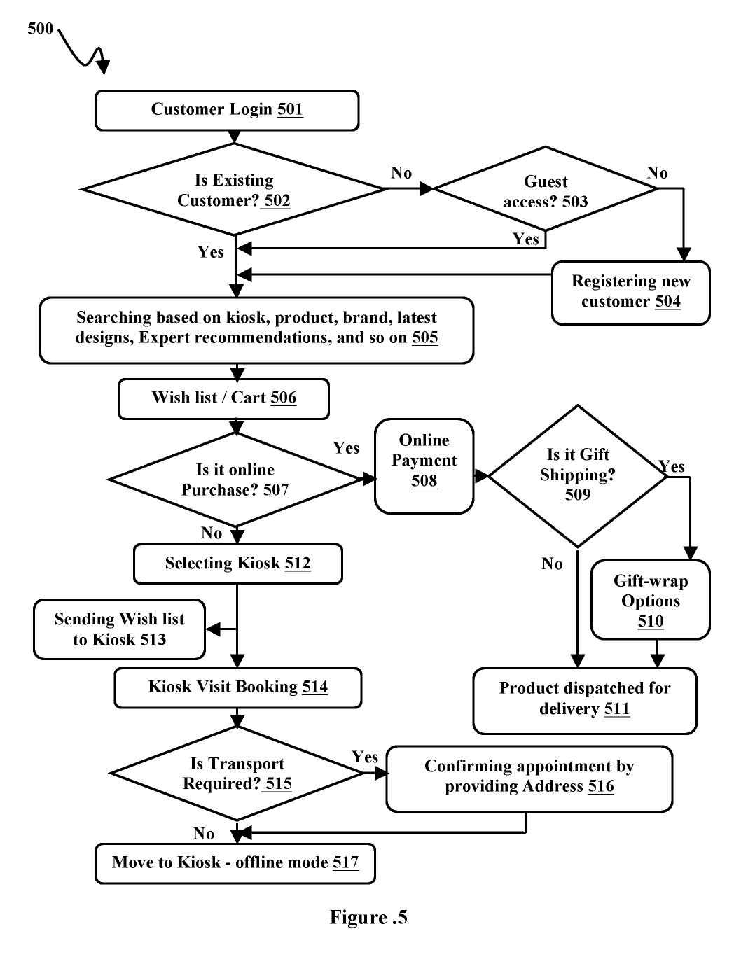

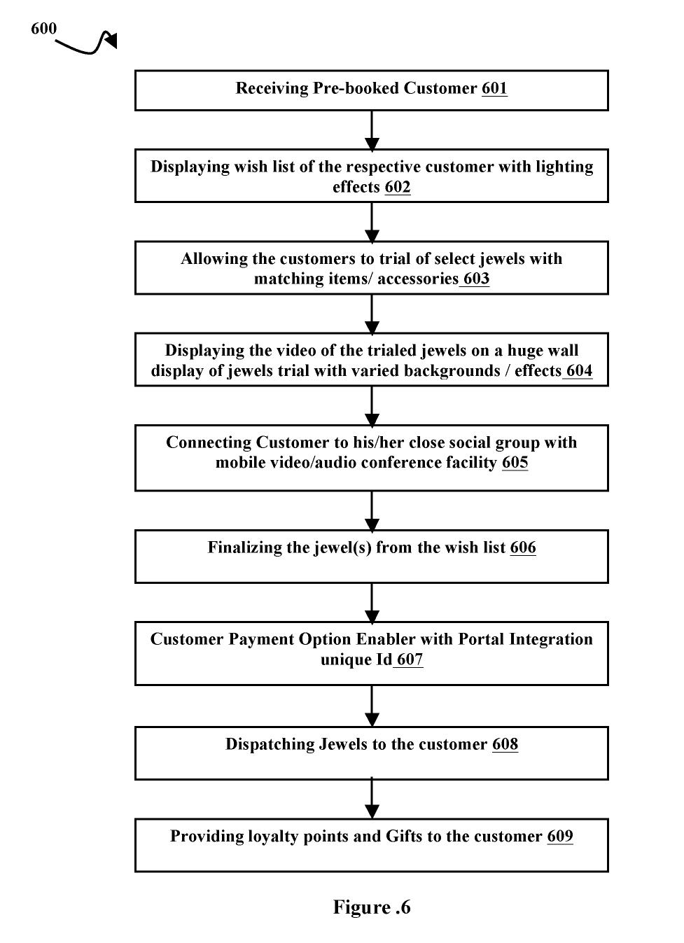

Exemplary methods for implementing system of online purchase of jewels by the customer and offline purchase of jewels by the customer at the jiosk are described with reference to FIG. 5 to FIG. 6. The methods are illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the spirit and scope of the subject matter described herein. In the context of software, the operations represent computer instructions that, when executed by one or more processors, perform the recited operations.

According to an embodiment, a method for online purchase of jewels by the customer can be achieved by allowing the customer to login to the system after registration and providing them a search engine to search the database to select the jewels of their interest. After selecting the jewels, the customer can decide for purchasing either through online or at the offline jiosk. If the customer request for trial of the jewels then prior appointment has been made by the jiosk-visit booking module. Further, the transport requirement for visiting the jiosk is required means then the transport is arranged accordingly.

According to an embodiment, a method for offline purchase of jewels by the customer at the jiosk is developed to perform purchase of jewels after performing multiple trials on the wishlist jewels. The jiosk has a separate space for dealing with the customer who has an appointment. The pre-booked customer's jewels of interest are displayed in front of them with lighting effects. The offline jiosk representative allows the customer to perform trial on the jewels of interest. For more convincing selection the trial on the jewels of interest is projected on the huge wall display and further the customer is allowed to make a video and audio conference with the group of their interest. After finalizing the jewels, the mode of payment is also decided by the customer. The gift shipping facility and other offerings from the offline jiosk are delivered to the customer.

FIG. 5 illustrates a flowchart 500 for methods of online purchase of jewels by the customer, according to an embodiment. In which the customer has to login 501 to the system to access the search engine. According to the embodiment, the method checks the for the customer status that is whether the customer is existing or new customer 502. If the customer is new customer then the process checks the purpose of visit by knowing whether the new customer wants guest access 503 or registration 504. After knowing the identity of the customer, the search engine allows the customer to perform the search. The searching process is performed based on jiosk, product, brand, latest designs, expert recommendations, and so on 505. After searching, the selected jewels are added to the cart or wishlist. For guest access the customer can able to perform only like option, which is specified in the product image. Whereas the existing or new customer can perform, buy or like to buy or trial and buy options. If the customer selects buy option means then the customer is requesting for online payment 507 and then the payment has to be made online 508 by the customer. Further the process checks the customer whether he needs gift-shipping 509. If the customer requires gift shipping then the product is gift wrapped using the gift-wrap option 510 and dispatched to the respective address 511, otherwise the product is dispatched 511 to the concern address without gift-wrap.

In the exemplary embodiment, if the customers selects the try and buy or likes to buy option while short-listing jewels, the customer has to select the jiosk 512 according to the wishlist. After completion of selection process of jiosk 512, the wishlist of each customer is sent to the jiosk 513. In the process, the customer gets an appointment from the respective jiosk for trialing the jewels by booking jiosk visit 514. Further, the need for the transport has been checked with the customer 515 and then after confirmation from the customer with the address 516, the transport is arranged by the respective jiosk to the customer. Then the process is moved to the offline mode 517 by stopping the online process.

FIG. 6 illustrates a process 600 for offline purchase of jewels by the customer at the jiosk, according to an embodiment. In which, the pre-booked customer is received at the offline jiosk for performing trials 601 before finalizing the jewels. Then the offline jiosk representative allows the customer to stay in the jiosk sale space, which is the reserved place for the pre-booked customer. In that jiosk sale space the jiosk representative displays the wishlist of the respective customer with lighting effects 602. Where, the jiosk representatives allow the customers to trial of select jewels with matching items/accessories 603 for letting the customer to take decision. After that for more convincing decision, the trials are projected on the huge display of jewels' trial on the wall with varied backgrounds/effects to the customer 604. Further, the customer is connected with a mobile video and audio conference facility to his/her close social group if required 605. After that, the jewel(s) is finalized from the wish list 606 and then the payment is acquired from the customer by enabling with portal integration unique Id 607. After payment, the Jewels are dispatched to the customer 608 and loyalty points and gifts are provided to the customer 609.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A system for searching precious jewels/ornaments through online and purchasing the selected precious ornaments/jewels by enhancing customer experience in reality comprises at least an interfacing device 101a, internet/network 102, retailer jiosk 103 and server engine 109;
wherein the server engine comprises system engine 111, and database 110;
wherein the system engine 111 includes,
a customer registration module 202 configured for registering the customer 101 by means of interfacing device 101a;
a login module 204 configured for enabling the existing customer to login to the system;
a search engine module 205 configured for allowing the customer to perform searches to select the jewels of their interest;
a wish list module 206 configured for performing the separation of the jewels in the selected jewels list according to their purpose and jiosks jewels;
a payment module 207 configured for processing the purchase payment through online or at the kiosks; and
a kiosk-visit booking module 209 configured for getting an appointment from the retailer kiosk for making trial on the selected wish list jewels.

2. The system of claim 1, wherein said customer registration module 202 further configured for registering the new customer to the system by acquiring the customer details such as address, contact number and so on.

3. The system of claim 1, wherein said login module 204 further configured for enabling the existing customer to login to the system by using their previous identity and password.

4. The system of claim 1, wherein said search engine module further configured for searching precious ornaments/jewels of all varieties present in the database, wherein the database includes brand details, retailer jewellery or kiosks, expert suggestions and latest designs, and so on.

5. The system of claim 1, wherein said payment module further configured for processing the purchase payment through online or at the kiosk according to the customer's preference; further the system allows the customer to make the payment by means of debit or credit cards or as cash only at the kiosk.

6. The system of claim 1, wherein said system engine further includes a kiosk transport module 210 configured for confirming the kiosk-visit appointment by specifying a date and time, sent to the customer through mail and SMS to the customer's registered mobile number.

7. The system of claim 1, wherein said system engine further includes an item/gift delivery module 211 configured for dispatching the jewels with a gift to the customer according to their preference.

8. A method for purchasing jewels through online searching and finalizing after trial at the kiosk comprising of online process and offline process; wherein the online process comprising the step of,
registering and logging in to the system as a new or existing customer;
searching for the jewels of interest using the various brands, kiosks, products;
designs, according to the purpose or occasions;
adding shortlisted jewels to the wish list or cart;
providing option for the payment using debit or credit cards;
booking for kiosk visit for making trial on the wish list jewels; and
facilitating transport for the customer to reach the kiosk on time.

9. The method of claim 8, wherein the offline process at the kiosk comprising the steps of,
receiving pre-booked customer to a showroom sale space at the kiosk for making trial on the wish list jewels;
displaying the respective wish list jewels to the corresponding customer with lighting effects;
allowing the customers to trial on the selected jewels;
displaying the video of the trialed jewels on a huge wall display;
connecting the customers to a group of their interest by video and audio conference if required;
finalizing the jewel from the wish list by getting confirmation from the customer;
acquiring payment from the customer by means of debit card or credit card or cash;
dispatching jewels to the customer as gift wrapped according to the customer's preference; and
providing loyalty points and gifts to the customer after purchasing the jewel.
